(19) United States
(12) Patent Application Publication
(10) Pub. No.: US 2004/0228592 A1
(43) Pub. Date: Nov. 18, 2004

(54) Photonic band gap optical fiber

(76) Inventors: Alexander L. Gaeta, Ithaca, NY (US); Michael T. Gallagher, Corning, NY (US); Karl W. Koch, Elmira, NY (US); Dmitre G. Ouzounov, Ithaca, NY (US); Natesan Venkataraman, Corning, NY (US); James A. West, Painted Post, NY (US)

Correspondence Address: CORNING INCORPORATED, SP-TI-3-1, CORNING, NY, 14831

(21) Appl. No.: 10/815,082

(22) Filed: Mar. 31, 2004

Related U.S. Application Data
(60) Provisional application No. 60/459,691, filed on Apr. 1, 2003.

(51) Int. Cl. G02B 6/20

(52) U.S. Cl. 385/125

(57) ABSTRACT

The present invention is directed toward photonic band gap optical fibers having low optical loss and low optical nonlinearity. According to one embodiment of the invention, a photonic band gap fiber includes a cladding region formed from a photonic band gap structure, the optical energy having a wavelength within the photonic band gap of the photonic band gap structure; and a core region surrounded by the photonic band gap structure. The photonic band gap fiber guides the optical energy substantially within the core region with a loss of less than about 300 dB/km. According to another embodiment of the invention, an optical fiber guides optical energy in a mode having a nonlinear index of refraction of less than about 10⁻¹⁸ cm²/W. According to another embodiment of the invention, an optical fiber supports a soliton having a peak power of greater than about 1 MW.

### BACKGROUND OF THE INVENTION

1. Field of the Invention

The present invention relates generally to optical fibers, and more specifically to photonic band gap optical fibers.

2. Technical Background

Optical fibers formed completely from glass materials have been in commercial use for more than two decades. Although such optical fibers have represented a leap forward in the field of telecommunications, work on alternative optical fiber designs continues. One promising type of alternative optical fiber is a microstructured optical fiber, which includes holes or voids running longitudinally along the fiber axis. The holes generally contain air or an inert gas, but may also contain other materials.

Microstructured optical fibers may be designed to have a wide variety of properties, and may be used in a wide variety of applications. For example, microstructured optical fibers having a solid glass core and a plurality of holes disposed in the cladding region around the core have been constructed. The arrangement, spacings and sizes of the holes may be designed to yield microstructured optical fibers with dispersions ranging anywhere from large negative values to large positive values. Such fibers may be useful, for example, in dispersion compensation. Solid-core microstructured optical fibers may also be designed to be single mode over a wide range of wavelengths. Solid-core microstructured optical fibers generally guide light by a total internal reflection mechanism; the low index of the holes can be thought of as lowering the effective index of the cladding region in which they are disposed.

One especially interesting type of microstructured optical fiber is the photonic band gap fiber. Photonic band gap fibers guide light by a mechanism that is fundamentally different from the total internal reflection mechanism. Photonic band gap fibers have a photonic band gap structure formed in the cladding of the fiber. The photonic band gap structure may be, for example, a periodic array of holes having a spacing on the order of the wavelength of light. The photonic band gap structure has a range of frequencies and propagation constants, known as the band gap, for which light is forbidden from propagating in the photonic band gap structure. The core of the fiber is formed by a defect in the photonic band gap structure cladding. For example, the defect may be a hole of a substantially different size and/or shape than the holes of the photonic band gap structure. Alternatively, the defect may be a solid structure embedded within the photonic band gap structure. Light introduced into the core will have a propagation constant determined by the frequency of the light and the structure of the core. Light propagating in the core of the fiber having a frequency and propagation constant within the band gap of the photonic band gap structure will not propagate in the photonic band gap cladding, and will therefore be confined to the core. A photonic band gap fiber may have a core that is formed from a hole larger than those of the surrounding photonic band gap structure; in such a hollow-core fiber, the light may be guided within the core hole.

There has been significant interest in the potential of photonic band gap guidance in optical fibers. While the theory of guidance in these fibers has been described, actual fabrication and demonstration of optical properties of photonic band gap fibers has been relatively rare. The photonic band gap fibers that have been demonstrated have suffered from high loss; the lowest losses reported have been on the order of 1000 dB/km. In order to be of significant practical interest, photonic band gap fibers must have much lower losses.

### SUMMARY OF THE INVENTION

One aspect of the present invention relates to an optical fiber for the transmission of optical energy, the optical fiber including a cladding region formed from a photonic band gap structure, the optical energy having a wavelength within the photonic band gap of the photonic band gap structure; and a core region surrounded by the photonic band gap structure, wherein the photonic band gap fiber guides the optical energy substantially within the core region with a loss of less than about 300 dB/km.

Another aspect of the present invention relates to an optical fiber for the transmission of optical energy, the optical fiber including a core region; and a cladding region, wherein the optical fiber guides the optical energy in a mode having a nonlinear refractive index of less than about 10⁻¹⁸ cm²/W.

Another aspect of the present invention relates to an optical fiber including a core region; and a cladding region, wherein the optical fiber is capable of supporting a temporal soliton having a peak power of greater than about 1 MW.

The optical fibers of the present invention result in a number of advantages over prior art photonic band gap fibers. For example, the photonic band gap fibers of the present invention have much lower optical losses than prior art photonic band gap fibers, and may therefore find utility in, for example, transmission of optical signals and dispersion compensation. The modes guided by the photonic band gap fibers of the present invention may have an extremely low nonlinearity; the photonic band gap fibers may therefore be useful for the transmission of high power optical energy (e.g. from a high power laser). The photonic band gap fibers of the present invention can support solitons having high peak power.

Additional features and advantages of the invention will be set forth in the detailed description which follows, and in part will be readily apparent to those skilled in the art from the description or recognized by practicing the invention as described in the written description and claims hereof, as well as in the appended drawings.

It is to be understood that both the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification. The drawings are not necessarily to scale, and sizes of various elements may be distorted for clarity. The drawings illustrate one or more embodiment(s) of the invention, and together with the description serve to explain the principles and operation of the invention.

### BRIEF DESCRIPTION OF THE DRAWINGS

FIG. 1 is a cross-sectional schematic view of a photonic band gap fiber of the present invention;

FIG. 2 is a cross-sectional schematic view of two photonic band gap structures having different pitches and hole sizes;

FIG. 3 is a cross-sectional schematic view of a method of fabricating the photonic band gap fibers of the present invention;

FIG. 4 is a cross-sectional schematic view of the stacked assembly of Example 1;

FIG. 5 is a cross-sectional schematic view of the assembly and handle of Example 1;

FIG. 6 is a cross sectional view of the etched body of Example 1;

FIG. 7 is a cross-sectional view of the photonic band gap fiber of Example 1;

FIG. 8 is a diagram of the theoretical and experimental mode profiles for the fundamental mode of the photonic band gap fiber of Example 1;

FIG. 9 is a diagram of the theoretical and experimental mode profiles for the first higher-order mode of the photonic band gap fiber of Example 1;

FIG. 10 is a graph of attenuation vs. wavelength for the photonic band gap fiber of Example 1;

FIG. 11 is a graph of dispersion vs. wavelength the photonic band gap fiber of Example 1;

FIG. 12 is a graph showing spectral details of the input and output pulses for a coupled pulse energy of 700 nJ into a 3.5 m length of the photonic band gap fiber of Example 1;

FIG. 13 is a graph of output pulse width and time-bandwidth product vs. pulse energy at 1480 nm for the photonic band gap fiber of Example 1; and

FIG. 14 is a graph of wavelength shift vs. pulse energy for 130 fs 1480 nm pulses coupled into a 3.5 m length of the photonic band gap fiber of Example 1.

### DETAILED DESCRIPTION OF THE PREFERRED EMBODIMENTS

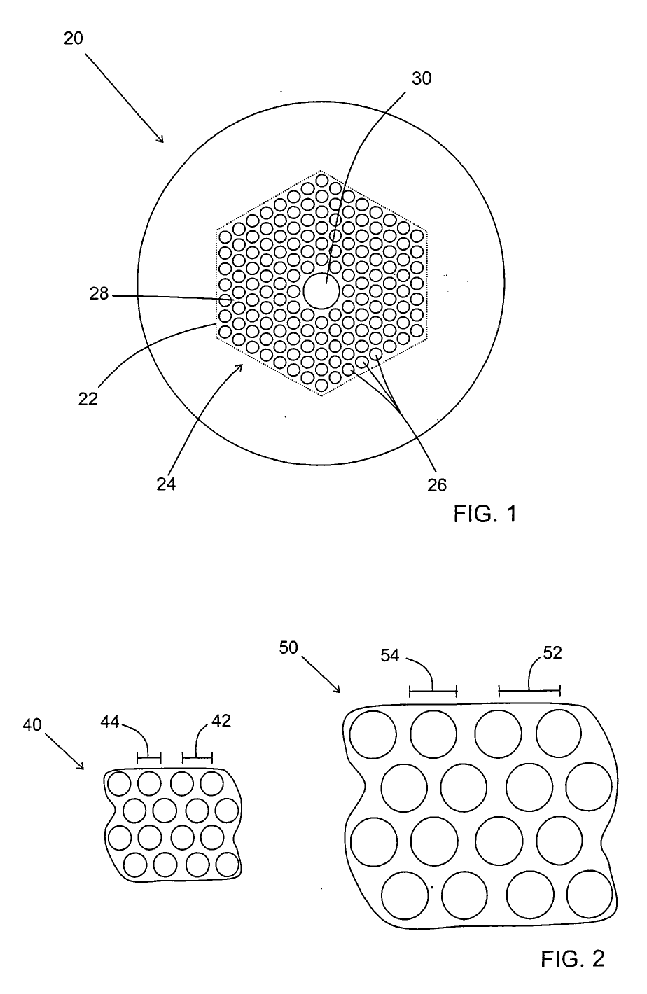

One aspect of the present invention relates to a photonic band gap fiber. FIG. 1 is a cross-sectional schematic view of an embodiment of a photonic band gap fiber according to the present invention. Photonic band gap fiber 20 includes a cladding region 22 formed from a photonic band gap structure 24. In the Example of FIG. 1, the photonic band gap structure 24 includes a periodic array of holes 26 formed in the matrix material 28 of cladding region 22. Holes 26 of FIG. 1 are schematically depicted as being circular in cross-section; the skilled artisan will recognize that the holes may have a substantially different cross-sectional shape (e.g. square, triangular, hexagonal). Photonic band gap fiber 20 also includes core region 30, which is surrounded by photonic band gap structure 24 of cladding region 22. In the example of FIG. 1, core region 30 is formed as a hole in matrix material 28. The hole defining core region 30 is much larger than the holes 26 of photonic band gap structure; as such, core region 30 acts as a defect in photonic band gap structure 24. Core region 30 may be composed of an inert gas such as nitrogen or argon, air, or a liquid. Core region 30 may also be a region of substantial vacuum (e.g. less than about 20 mm Hg).

The photonic band gap fibers according to this embodiment of the invention guide light substantially within the core region. Optical energy introduced into the core region will have a propagation constant determined by the frequency of the light and the structure of the core region. Optical energy propagating in the core region of the fiber having a frequency and propagation constant within the band gap of the photonic band gap structure will not propagate in the photonic band gap structure of the cladding region, and will therefore be confined to the core region. The photonic band gap fibers of the present invention guide optical energy having a frequency within the band gap of the photonic gap structure substantially within the core region with a loss of less than about 300 dB/km. Desirable photonic band gap fibers of the present invention guide optical energy having a frequency within the band gap of the photonic gap structure substantially within the core region with a loss of less than about 200 dB/km. Especially desirable photonic band gap fibers of the present invention guide optical energy having a frequency within the band gap of the photonic band gap structure substantially within the core region with a loss of less than about 50 dB/km. In certain embodiments of the invention, photonic band gap fibers guide optical energy having a frequency within the band gap of the photonic band gap structure substantially within the core region with a loss of less than about 20 dB/km.

Unlike in conventional optical fibers, the guidance of optical energy in photonic band gap fibers does not rely on the refractive index of the core being higher than the refractive index of the cladding. As such, the core region may have a lower effective refractive index than that of the cladding region at the wavelength of the optical energy. As used herein, the effective refractive index of a region is defined as

$${n}_{eff} = \sqrt{{\sum }_{i = 1}^{z} {f}_{i} \cdot {n}_{i}^{2}}$$

where n_{eff} is the effective refractive index, z is the total number of different refractive indices nᵢ in the photonic band gap structure, and f is the volume fraction for refractive index nᵢ. For example, in the photonic band gap fiber depicted in FIG. 1, if core region 30 is filled with a gas or a vacuum, it will have a refractive index of about 1 at near infrared wavelengths. The effective refractive index of cladding region 22 will be higher than that of core region 30 due to the presence of matrix material 28.

As the skilled artisan will appreciate, the exact frequencies spanned by the band gap of the photonic band gap structure depend strongly on its structural details. The skilled artisan may adjust the band gap by judicious design of the photonic band gap structure. Computational methodologies familiar to the skilled artisan may be advantageously used in the design of the photonic band gap structure. In one such technique, dielectric structures having a desired shape and refractive index profile may be defined geometrically. The frequencies and electric and magnetic fields of electromagnetic modes in a given dielectric structure is calculated by computer solution of Maxwell's equations. A trial solution is constructed by expressing the magnetic field as a sum of plane waves, with arbitrary (random number) coefficients. Maxwell's equations are solved by varying the plane wave coefficients until the electromagnetic energy is minimized. This is facilitated by a preconditioned conjugate gradient minimization algorithm. The mode frequencies, electric fields, and intensity distributions for each mode of the defined dielectric structure are thereby determined. This technique is described in more detail in “Block-Iterative frequency-domain methods for Maxwell's equations in a planewave basis”, Johnson, S. J. and Joannopoulos, J. D., Optics Express, 8(3), 173-190 (2001). The skilled artisan will appreciate that the wavelength range of the band gap scales with the size of the photonic band gap structure. For example, as shown in FIG. 2, if a triangular array of holes 40 has a pitch 42 of about 4.7 μm, a hole size 44 of about 4.6 μm, and a band gap ranging in wavelength from about 1400 nm to about 1800 mm, then a scaled triangular array of holes 50 having a pitch 52 of about 9.4 μm and a hole size 44 of about 9.2 μm will have a band gap ranging in wavelength from about 2800 nm to about 3600 mm.

The photonic band gap fibers of the present invention may be constructed to guide optical energy having a wide variety of wavelengths. In desirable embodiments of the invention, a photonic band gap fiber is configured to guide optical energy having wavelength between about 150 nm and about 11 μm. In other desirable embodiments of the invention, a photonic band gap fiber is configured to guide optical energy having wavelength greater than about 1000 mm. In other embodiments of the invention, a photonic band gap fiber is configured to guide optical energy having a wavelength less than about 11 μm. In embodiments of the invention that are especially desirable for telecommunications applications, a photonic band gap fiber guides optical energy having a wavelength of between about 1400 nm and 1500 nm with a loss of less than about 20 dB/km. In other embodiments of the invention that are especially desirable for telecommunications applications, a photonic band gap fiber guides optical energy having a wavelength of between about 1680 nm and about 1900 nm with a loss of less than about 20 dB/km. As the skilled artisan will appreciate, the photonic band gap fibers of the present invention may be designed to guide wavelengths other than those specified herein.

In order to ensure single- or few-moded operation at a desired wavelength, it is desirable for the core region to have a relatively small cross-sectional area. For example, in desirable embodiments of the present invention, the core region has a maximum diameter less than about four times the pitch of the photonic band gap structure of the cladding region. In especially desirable embodiments of the present invention, the core region has a maximum diameter no greater than about three times the pitch of the photonic band gap structure of the cladding region.

Another embodiment of the present invention relates to photonic band gap fibers that support guided modes having extremely low nonlinearities. In conventional optical fibers, light is guided in a glass material; the guided modes have effective nonlinear refractive indices (n₂) ranging from 2×10⁻¹⁶ cm²/W to 4×10⁻¹⁶ cm²/W. In the photonic band gap fibers of the present invention, light may guided substantially in a gaseous material. As such, extremely low nonlinearities may be achieved. In the photonic band gap fibers according to one embodiment of the present invention, optical energy may be guided in a mode having an effective nonlinear refractive index n₂ of less than about 10⁻¹⁸ cm²/W. In desirable photonic band gap fibers of the present invention, optical energy may be guided in a mode having an effective nonlinear refractive index n₂ of less than about 5×10⁻¹⁹ cm²/W. Photonic band gap fibers with low nonlinearities may find utility in the transmission of high power optical energy (e.g. from a high power laser). As will be described in more detail below, the photonic band gap fibers according to this embodiment of the invention may be capable of supporting the propagation of solitons having peak powers of greater than about 1 MW. The photonic band gap fibers according to this embodiment of the present invention may be, for example, the low-loss photonic band gap fibers described hereinabove.

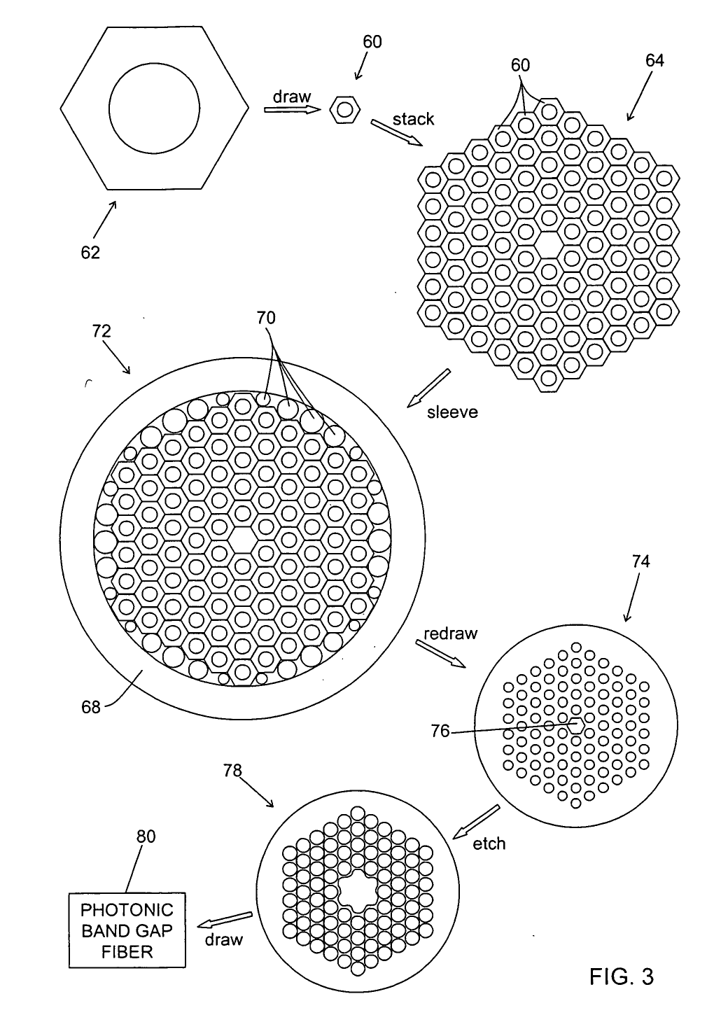

The photonic band gap fibers of the present invention may be fabricated using methods analogous to those used in fabricating conventional optical fibers. In one suitable method, a preform having the desired arrangement of core and cladding features is formed, then drawn into fiber using heat and tension. An example of a method for making a photonic band gap fiber is shown in cross-sectional detail in FIG. 3. Hollow hexagonal capillaries 60 are made by drawing a hexagonal-sided glass tube 62 using heat and tension. These capillaries are stacked together to form an assembly 64 having a periodic lattice structure. One or more capillaries 60 are removed at the center of assembly 64; in order to make a hollow-core fiber, a thin tube (not shown) may optionally be inserted into the hole formed by the removal of the central capillary as shown in FIG. 3. In order to make a solid core fiber, a solid hexagonal rod may be inserted into the hole. Stacked assembly 64 is positioned inside a sleeve tube 68, using solid rods 70 to hold the assembly in place. Sleeved assembly 72 is redrawn using heat and tension to reduce its size, forming a substantially monolithic body 74. It may be desirable to pull a vacuum on the spaces between the stacked capillaries during the redraw step in order to close any interstitial voids between the external surfaces of the capillaries. Body 74 is then etched with NH₄F—HF to increase the sizes of the holes of the periodic array as well as of the hole of the core region. Redraw and etching procedures are described, for example, in U.S. Pat. No. 6,444,133, the specification of which is hereby incorporated herein by reference in its entirety. In the etching step, the walls separating the hole 76 of the core region from the innermost course of holes of the photonic band gap structure are removed, greatly enlarging the size of the hole of the core region. Redrawn, etched body 78 is drawn into a photonic band gap fiber 80 using methods familiar to the skilled artisan. Before being drawn into fiber, redrawn etched body 76 may be sleeved with an overclad tube (not shown) to provide a fiber with a larger outer diameter. Photonic band gap fiber 80 may be coated with one or more polymeric optical fiber coatings, as is common in the optical fiber art. A suitable fabrication procedure is described in more detail in Example 1, below.

It may be desirable to form the preform so that the material of an inner portion of the preform has a higher softening point than the material of an outer portion of the preform, as is described in commonly owned U.S. patent application Ser. No. 10/171,337, filed on Jun. 12, 2002 and entitled “MICROSTRUCTURED OPTICAL FIBERS AND METHODS AND PREFORMS FOR FABRICATING MICROSTRUCTURED OPTICAL FIBERS”, the specification of which is hereby incorporated herein by reference in its entirety. For example, the difference in softening points may be about 50° C. or greater, about 100° C. or greater, or even about 150° C. or greater. One way to achieve such a difference is to use silica glass for the capillaries, and a doped silica tube (e.g. germanium doped, fluorine doped, boron doped) as the sleeve tube. In cases where a specially-shaped core structure is used, it may be desirable to form the core structure from a material with an even higher softening point (e.g. tantalum-doped silica). Such a difference in softening point allows the inner portion of the preform to be at a somewhat higher viscosity during the draw, leading to less distortion of the inner portion of the structure.

In order to reduce the occurrence of breaks during the draw and lower the level of attenuation in the drawn fiber, it may be desirable to provide a preform having reduced levels of contaminants (e.g. particulate contaminants, organic contaminants, inorganic contaminants) as well as reduced levels of OH content (i.e. surface-adsorbed water). As such, it may be desirable to clean the preform at various stages of manufacture with a chlorine-containing gas (e.g. a mixture of chlorine and helium). As the skilled artisan will recognize, chlorine gas is effective at removing many types of contaminants. For example, chlorine gas may react with water (e.g. in the form of surface OH) and many inorganic contaminants to form volatile species that are removed in a subsequent purge cycle. Chlorine may also act to oxidize various organic species. It may also be desirable to include exposure to oxygen in a cleaning regimen in order to more fully remove organic contaminants. Cleaning process are described in detail in commonly owned U.S. patent application Ser. No. 10/298,374, filed on Nov. 18, 2002 and entitled “METHODS FOR MANUFACTURING MICROSTRUCTURED OPTICAL FIBERS WITH CONTROLLED CORE SIZE”, the specification of which is hereby incorporated herein by reference in its entirety.

The preforms used in making the optical fiber of the present invention may be made using other methods familiar to the skilled artisan. For example, redraw techniques may be used to reduce the preform diameter. Etching with SF₆, NF₃ or aqueous NH₄F—HF may be used to enlarge the size of the holes. Redraw and etching procedures are described, for example, in U.S. Pat. No. 6,444,133, the specification of which is hereby incorporated herein by reference in its entirety.

The preform may be drawn into microstructured optical fiber using methods familiar to the skilled artisan. Additionally, a pressure may be placed on the holes of the preform during the draw in order to keep them from closing due to surface tension. Alternatively, on the end of the preform opposite the drawn end, the holes may be closed in order to maintain a positive pressure inside the holes of the preform, thereby preventing them from closing due to surface tension. It may be desirable to place different pressures on different sets of holes of the preform, as is described in commonly owned U.S. patent application Ser. No. 10/171,335, filed Jun. 12, 2002 and entitled “METHODS AND PREFORMS FOR DRAWING MICROSTRUCTURED OPTICAL FIBERS”, the specification of which is hereby incorporated herein by reference in its entirety. For example, the large core hole of a photonic band gap fiber may be coupled to a first pressure system, and the holes of the photonic crystal structure may be coupled to a second pressure system. The first pressure system may be set to a lower pressure than the second pressure system so that the inner core hole does not expand relative to the holes of the photonic crystal structure.

The skilled artisan will recognize that other methods and materials may be used to make the photonic band gap fibers of the present invention. For example, extrusion techniques, such as those described in U.S. Pat. No. 6,260,388, may be used to make the photonic band gap fibers of the present invention.

Another embodiment of the present invention relates to an optical fiber capable of supporting a temporal soliton having a peak power of greater than 1 MW. As is familiar to the skilled artisan, a temporal soliton is an optical pulse that is transmitted along a length of optical fiber without spreading appreciably in pulse width. In soliton transmission, the interplay of dispersion and nonlinearity serves to maintain the temporal pulse envelope over long distances. In certain embodiments of the present invention, the temporal soliton may have a peak power of greater than 3 MW. The optical fiber according to this aspect of the present invention may be, for example, a hollow-core photonic band gap fiber as described above.

The invention will be further described by the following non-limiting Examples.

### EXAMPLE 1

### Fabrication

A photonic band gap fiber was fabricated as described below.

Silica tubing (HEREAUS F300) having an outer diameter of about 50 mm and an inner diameter of 25 mm was machined to yield blanks having a 47 mm apex-to-apex regular hexagonal cross-section with a 25 mm diameter circular hole centered in the regular hexagon. One regular hexagonal blank was then drawn to a size of 1.5 mm flat-to-flat, and cut to capillary segments 0.33 m in length. The individual capillaries were then capped on one end by sealing the hole shut in a flame.

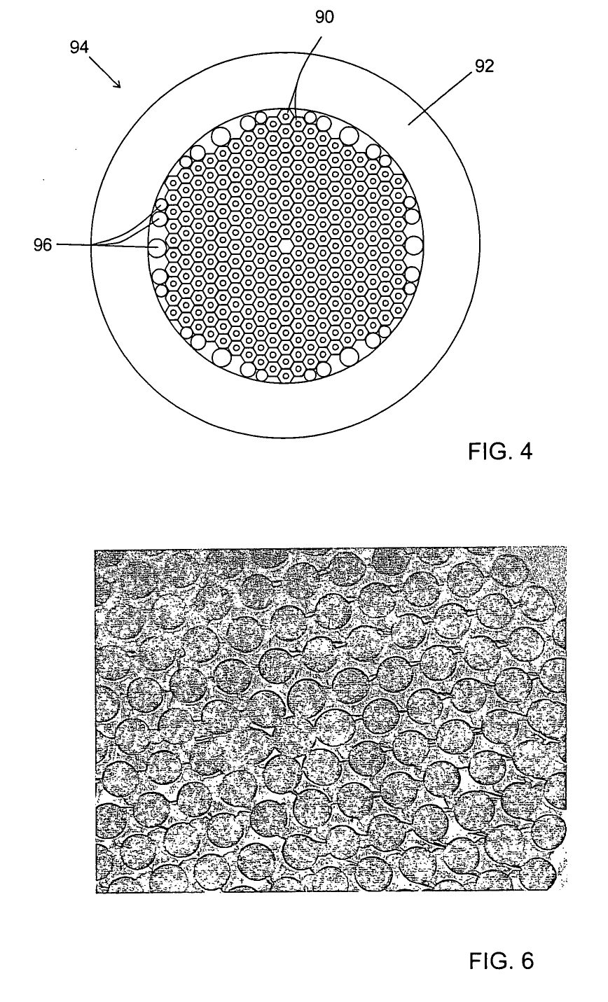

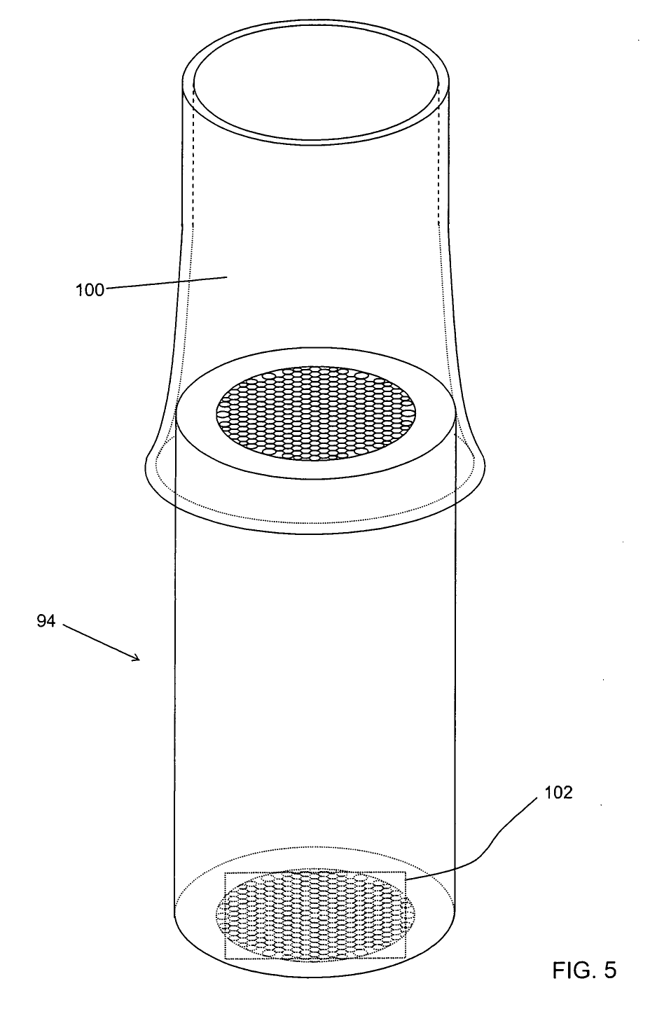

As shown in cross-sectional view in FIG. 4, capillaries 90 were stacked in a hexagonal close-packed lattice forming a regular hexagon with 10 capillaries on a side, and arranged in a 40 mm inner diameter×50 mm outer diameter×0.33 m long HEREAUS F300 silica tube 92 to form an assembly 94. Filler rods 96 were used to fix the lattice in place in the tube. The centermost capillary was removed from the lattice, and a thin-walled tube (1.5 mm OD×1.4 mm ID, capped as described above) was inserted in its place. The capped ends of the capillaries were positioned on the same end of the assembly. As shown in perspective view in FIG. 5, a hollow glass handle 100 was attached to the capped end of assembly 94, with the hollow inside of handle 100 in fluid communication with the outsides of the stacked capillaries. A flat piece of glass 102 was attached to the uncapped end of assembly 94 without sealing shut the holes of the capillaries. Piece of glass 102 was roughly square in shape, with a diagonal dimension of just large enough to hold capillaries 90 in tube 92.

Assembly 94 was redrawn in a furnace at a temperature of 2012° C. at a draw speed of 400 mm/min. During the redraw, the assembly was fed in the direction of the redraw at a rate of 7.84 mm/min. A partial vacuum (˜0.84 mm Hg) was pulled on the interstitial voids through the hollow handle to collapse them during the redraw. Several lengths of redrawn body were made from the assembly. A ˜⅓ m length of redrawn body was etched with 28 wt % NH₄F—HF at 58° C. for 90 minutes to yield the etched preform 110 shown in cross-sectional view in FIG. 6. The etched preform so formed had a diameter of 6.9 mm.

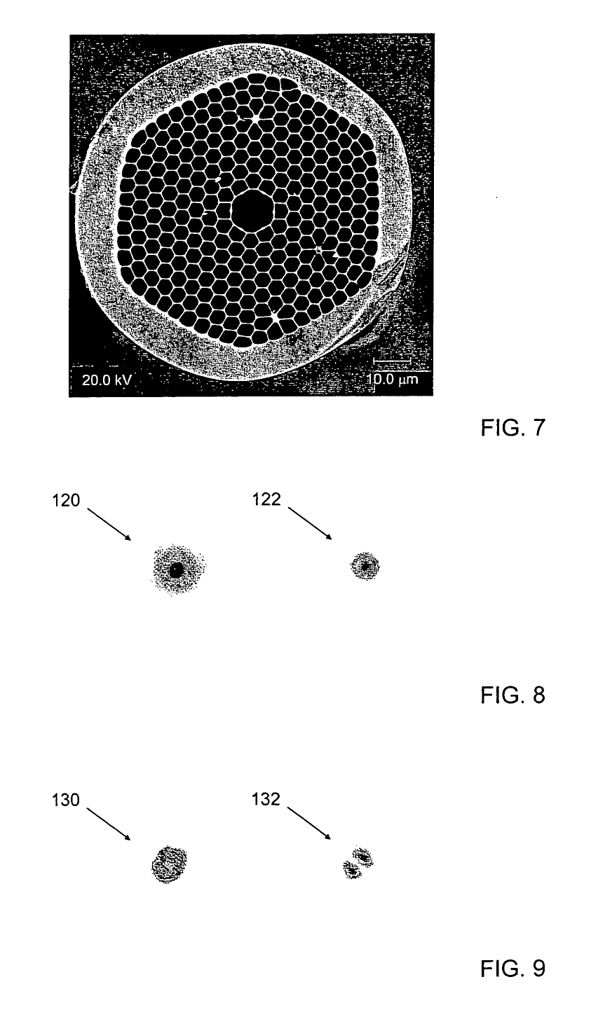

A solid glass rod was sealed to one end of the etched preform, effectively capping the end of the preform. The etched preform was drawn into fiber from the end opposite the capped end at a furnace temperature of 1985° C. and a draw speed of 40-60 m/min to yield the photonic band gap fiber shown in FIG. 7. The etched preform was fed in the direction of the draw at a rate of 5.3 mm/min. The drawn fiber had an outer diameter of about 100 μm. The drawn fiber was coated with an acrylate-based polymeric coating, as is customary in the art. About 2 km of fiber was drawn and spooled in lengths of ˜100-200 m for further measurement. The photonic crystal structure had a pitch of about 4.7 μm, a hole diameter of about 4.6 mm, and a core hole diameter of about 12.7 μm. These dimensions remained roughly constant over the length of the fiber.

### EXAMPLE 2

### Measurement of Transmission

The spectral transmission and modal properties of a ˜100 m length of the photonic band gap fiber of Example 1 were measured using a broadband EELED source. To excite different propagation modes, light from a fiber-coupled EELED source was butt-coupled via an SMF-28™ fiber into the photonic band gap fiber. In order to verify that the light is guided within the air core, the output facet of the fiber was imaged with a Hamamatsu C2741 infrared camera. By changing the launch angle, both the fundamental and first higher order modes were excited, as shown in FIGS. 8 and 9. In FIG. 8, the experimental (120) and theoretical (122) mode profiles are shown for the fundamental mode. In FIG. 9, the experimental (124) and theoretical (126) mode profiles are shown for the first higher-order mode.

In order to measure the transmission loss of the 100 m section of photonic band gap fiber was measured using a cutback method. A commercially available Photon Kinetics measurement bench was used with some slight modifications. The source light was flood launched into a 1 m length of CS980™ optical fiber, available from Corning Incorporated of Corning, N.Y. The source light emerging from the CS980™ fiber was butt-coupled into the photonic band gap fiber. After each cleave of the photonic band gap fiber in the cutback measurement, the cleaved end was inspected to ensure that its quality was sufficient to avoid adversely affecting the measurement. The imaging system of the Photon Kinetics bench was used to ensure that the cleaved end of the fiber was always placed in the same position relative to the photodetector.

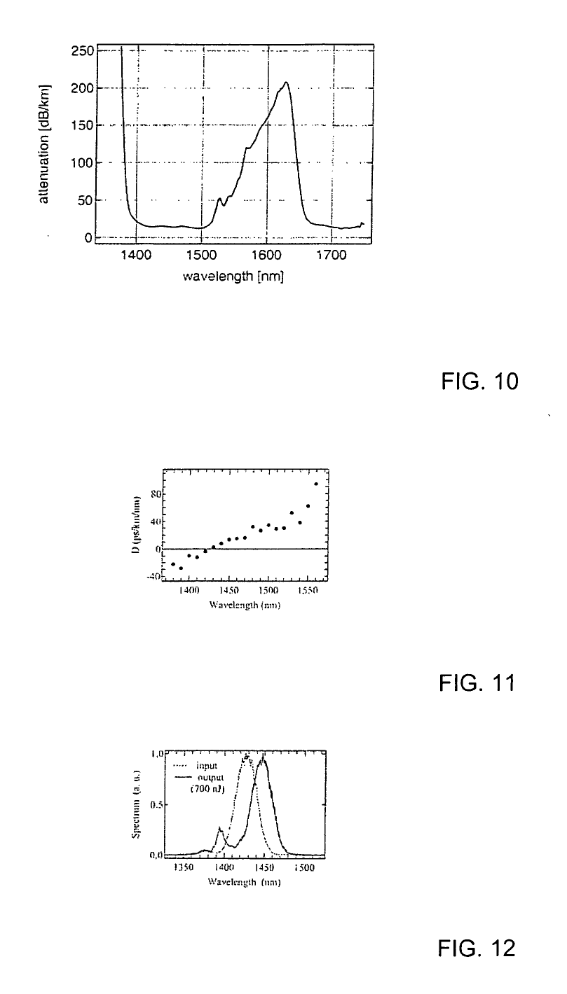

The optical attenuation of the 100 m length of photonic band gap fiber as a function of wavelength is shown in FIG. 10. The data of FIG. 10 was generated by subtracting the throughput of the full 100 m length of fiber from the throughput of a 2 m long cutback section. The measured data shows the lowest loss of 13 dB/km at a wavelength of 1500 nm, and losses up to about 200 dB/km within the 1520 nm-1660 nm wavelength band. The transmission window from 1395 to 1750 nm represents one band gap; the spectral features in the 1520 nm-1620 nm region are not believed to be due to a band gap edge, but rather to coupling between different propagation modes of the photonic band gap fiber.

### EXAMPLE 3

### Measurement of Nonlinear Effects

A femtosecond time-delay technique described in D. Ouzounov et al., Opt. Comm., 192, 219 (2001) was used to measure the group velocity dispersion of the photonic band gap fiber of Example 1. The femtosecond tunable source was a 1-kHz repetition rate optical parametric amplifier pumped by a Ti:sapphire system. The results of the dispersion measurement are shown in FIG. 11. The photonic band gap fiber has anomalous dispersion at wavelengths greater than 1425 nm. The slope of the dispersion curve indicates that the fiber is highly dispersive. Since air has negligible dispersion, the large total dispersion is a result of the waveguide dispersion of the photonic band gap fiber structure.

The effective nonlinearity of the fiber of Example 1 was determined by coupling pulses centered at the zero-dispersion wavelength and examining the output spectra as a function of pulse energy. The induced peak nonlinear phase shift can be estimated by comparing the shape of the output pulse spectra with the theoretically predicted spectrum. The output spectrum for a coupled pulse energy of 700 nJ is shown in FIG. 12. This spectrum exhibits a splitting that is nearly equal to the theoretical prediction, with a peak nonlinear phase shift of 1.5π. From this data, the effective nonlinearity parameter γ was calculated to be 2.1×10⁻⁸ W⁻¹/cm. The effective nonlinearity parameter γ is related to the nonlinear refractive index n₂ by the equation γ=2πn₂/λA_{ff}, where A_{eff} is the effective mode area, and λ is the wavelength of light. The mode diameter was 9 μm, making the nonlinear refractive index of the guided mode to be n₂˜3.02×10⁻¹⁹ cm²/W. This nonlinear refractive index is close to the measured value for air (n₂(air)˜2.9×10⁻¹⁹ cm²/W), confirming that the optical energy is transmitted chiefly through air in the guided mode.

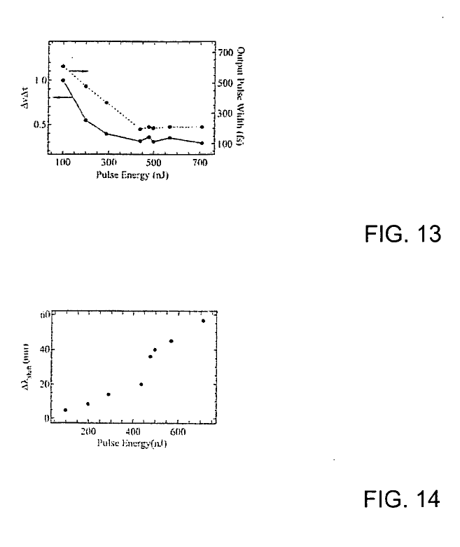

The photonic band gap waveguide of FIG. 1 has a small nonlinearity and large anomalous dispersion. As such, it is suitable for the transmission of high peak power temporal solitons. Pulses 130 fs in width centered at 1480 nm were coupled into a 3.5 m length of the photonic band gap fiber of Example 1. The output pulses were examined in both the time and the spectral domains. At this wavelength, the dispersion length of the photonic band gap fiber was 16 cm, so the total length of the photonic band gap fiber was approximately 22 dispersion lengths. A graph depicting output pulse width and time-bandwidth product as a function of pulse energy are shown in FIG. 13. The time-bandwidth product of the output pulses for pulse energies over 400 nJ is about 0.31, which indicates nearly transform-limited pulses (assuming sech² shape). Due to intrapulse Raman scattering, the central wavelength shifts toward longer wavelengths; this shift as a function of pulse energy is shown in FIG. 14. The peak powers of these solitons exceed 3 MW.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. An optical fiber for the transmission of optical energy, the optical fiber comprising:
a cladding region including a photonic band gap structure, the optical energy having a wavelength within the photonic band gap of the photonic band gap structure; and
a core region surrounded by the photonic band gap structure,
wherein the photonic band gap fiber guides the optical energy substantially within the core region with a loss of less than about 300 dB/km.

2. The optical fiber of claim 1 wherein the optical energy has a wavelength between about 150 nm and about 11 μm.

3. The optical fiber of claim 1 wherein the core region has a lower effective refractive index than the average refractive index of the photonic band gap structure.

4. The optical fiber of claim 1 wherein the core region is composed substantially of a gaseous material.

5. The optical fiber of claim 1 wherein the optical energy has a wavelength greater than about 1000 nm.

6. The optical fiber of claim 1 wherein the photonic band gap fiber guides the optical energy substantially within the core region with a loss of less than about 200 dB/km.

7. The optical fiber of claim 1 wherein the photonic band gap fiber guides the optical energy substantially within the core region with a loss of less than about 50 dB/km.

8. The optical fiber of claim 1 wherein the photonic band gap fiber guides the optical energy substantially within the core region with a loss of less than about 20 dB/km.

9. The optical fiber of claim 8 wherein the optical energy has a wavelength between about 1400 nm and about 1500 nm.

10. The optical fiber of claim 8 wherein the optical energy has a wavelength between about 1680 and 1900 nm.

11. The optical fiber of claim 1 wherein the optical energy is guided in a mode having a nonlinear refractive index of less than about 10⁻¹⁸ cm²/W.

12. The optical fiber of claim 1 wherein the optical signal is guided in a mode having a nonlinear refractive index of less than about 5×10⁻¹⁹ cm²/W.

13. The optical fiber of claim 1 wherein the optical fiber is capable of supporting a temporal soliton having a peak power of greater than about 1 MW.

14. The optical fiber of claim 1 having a dispersion of greater than 20 ps/nm/km at a wavelength within the photonic band gap.

15. The optical fiber of claim 1 wherein the optical fiber is fabricated by a stack-and-draw method.

16. The optical fiber of claim 1 wherein the optical fiber supports at least two modes guided substantially within the core.

17. The optical fiber of claim 1 wherein the optical energy propagates in the optical fiber with a wavelength and propagation constant within the band gap of the photonic band gap structure.

18. The optical fiber of claim 1, wherein the core region has a maximum diameter less than about four times the pitch of the photonic band gap structure of the cladding region

19. An optical fiber for the transmission of optical energy, the optical fiber comprising:
a core region; and
a cladding region,
wherein the optical fiber guides the optical energy in a mode having a nonlinear refractive index of less than about 10⁻¹⁸ cm²/W.

20. The optical fiber of claim 19 wherein the optical signal is guided in a mode having a nonlinear refractive index of less than about 5×10⁻¹⁹ cm²/W.

21. The optical fiber of claim 19 wherein the optical fiber is capable of supporting a temporal soliton having a peak power of greater than about 1 MW.

22. The optical fiber of claim 19 wherein the photonic band gap fiber guides the optical energy substantially within the core region with a loss of less than about 300 dB/km.

23. The optical fiber of claim 19 wherein the photonic band gap fiber guides the optical energy substantially within the core region with a loss of less than about 50 dB/km.

24. The optical fiber of claim 19, wherein the cladding region is formed from a photonic band gap structure, the soliton having a wavelength within the photonic band gap of the photonic band gap structure; and wherein the core region is surrounded by the photonic band gap structure.

25. An optical fiber comprising
a core region; and
a cladding region,
wherein the optical fiber is capable of supporting a temporal soliton having a peak power of greater than about 1 MW.

26. The optical fiber of claim 25, wherein the optical fiber is capable of supporting a temporal soliton having a peak power of greater than about 3 MW.

27. The optical fiber of claim 25, wherein the cladding region is formed from a photonic band gap structure, the soliton having a wavelength within the photonic band gap of the photonic band gap structure; and wherein the core region is surrounded by the photonic band gap structure.
